(19) United States
(12) Patent Application Publication
(10) Pub. No.: US 2013/0236656 A1
(43) Pub. Date: Sep. 12, 2013

(54) SELF-REDUCED METAL COMPLEX INKS SOLUBLE IN POLAR PROTIC SOLVENTS AND IMPROVED CURING METHODS

(71) Applicant: LIQUID X PRINTED METALS, INC., Pittsburgh, PA (US)

(72) Inventors: Richard D. MCCULLOUGH, Pittsburgh, PA (US); John BELOT, Rayland, OH (US); Rebecca POTASH, Duxbury, MA (US); Elizabeth SEFTON, Vienna, WV (US); Christiana COX, Pittsburgh, PA (US)

(73) Assignee: Liquid X Printed Metals, Inc., Pittsburgh, PA (US)

(21) Appl. No.: 13/777,374

(22) Filed: Feb. 26, 2013

Related U.S. Application Data
(60) Provisional application No. 61/603,852, filed on Feb. 27, 2012.

(51) Int. Cl. C09D 11/00; C07F 1/10

(52) U.S. Cl. CPC C09D 11/52; C07F 1/10
USPC 427/532; 252/519.21; 556/116; 427/126.1

(57) ABSTRACT

Metal complexes adapted to form metallic conductive films upon deposition and treatment. The complexes can have a high concentration of metal and can be soluble in polar protic solvent including ethanol and water. The metal complex can be a covalent complex and can comprise a first and second ligand. Low temperature treatment can be used to convert the complex to a metal. The metallic conductive film can have low resistivity and work function close to pure metal. Coinage metals can be used (e.g., Ag). The ligands can be dative bonding ligands including amines and carboxylate ligands. The ligands can be adapted to volatilize well. High yields of metal can be achieve with high conductivity.

### RELATED APPLICATIONS

This application claims priority to U.S. provisional application Ser. No. 61/603,852 filed Feb. 27, 2012, which is hereby incorporated by reference in its entirety.

### BACKGROUND

Printed electronics is projected to be a multi-billion business within the next 7-10 years, with the inks alone constituting 10-15% of that dollar amount, according to some sources. The increased interest in printable electronics as rapidly growing alternatives to silicon-based technologies is fueled by, among other things, the promise of large-area, flexible, lightweight and low-cost devices.

More particularly, a need exists for better methods for printing metals such as, for example, silver, gold, and copper. These metals are important chip components ranging from interconnects to organic field effect transistor source and drain electrodes. In general, improved compositions and methods for producing metal structures are needed, particularly for commercial applications and inkjet printing. See, for example, U.S. Pat. Nos. 7,270,694; 7,443,027; 7,491,646; 7,494,608 (assignee: Xerox); US Patent Publication 2010/0163810 (“Metal Inks”); US Patent Publication 2008/0305268 (“Low Temperature Thermal Conductive Inks”); US Patent Publication 2006/0130700 (“Silver Containing Inkjet Inks”); and US Patent Publication 2009/0120800 (“Organic Silver Complexes, Their Preparation Methods and their Methods for Forming Thin Layers”), all of which are incorporated herein by reference in their entireties.

In addition, a need exists for self-reducing metal complexes that are soluble in polar protic solvents including water. See, for example, U.S. Pat. No. 7,824,580 (Silver-Containing Aqueous Formulation and Its Use to Produce Electrically Conductive or Reflective Coatings) and U.S. Pat. No. 8,022,580 (Water-Based Inks for Ink-Jet Printing), both of which are incorporated herein by reference in their entireties.

Finally, better methods are need to produce high quality metal films from metal complexes.

### SUMMARY

Provided herein are compositions, devices, methods of making compositions and devices, and methods of using compositions and devices, among other embodiments.

One embodiment provides a composition comprising at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and wherein the metal complex has a solubility at 25° C. of at least 100 mg/ml in at least one polar protic solvent.

In one embodiment, the metal complex has a solubility at 25° C. of at least 250 mg/ml in at least one polar protic solvent. In another embodiment, the metal complex has a solubility at 25° C. of at least 500 mg/ml in at least one polar protic solvent.

In one embodiment, the composition comprises at least one polar protic solvent. In another embodiment, the composition comprises water or ethanol. In a further embodiment, the composition comprises PEG or a PEG mixture (PEG is poly(ethylene glycol)). In one embodiment, the composition further further comprises at least one polar protic solvent, wherein the polar protic solvent is water, ethanol, amine or PEG.

In one embodiment, the metal complex comprises only one metal.

In one embodiment, the metal is in an oxidation state of (I) or (II). In another embodiment, the metal is silver, gold, copper, platinum or ruthenium. In a further embodiment, the metal is silver.

In one embodiment, the first ligand is a monodentate ligand, a bidentate ligand, or a tridentate ligand.

In one embodiment, the first ligand comprises at least two amine groups. In another embodiment, the first ligand comprises at least two unsubstituted amine groups. In a further embodiment, the first ligand comprises at least two amines groups, wherein at least one amine group is substituted with a polar group or a linear alkane. In an additional embodiment, the first ligand is ethylenediamine.

In one embodiment, the first ligand volatizes upon heating at a temperature of 200° C. or less. In another embodiment, the first ligand volatizes upon heating at a temperature of 150° C. or less.

In one embodiment, the second ligand is a carboxylate. In another embodiment, the second ligand is a carboxylate comprising a linear, branched or cyclic alkyl group. In a further embodiment, the second ligand is a carboxylate represented by —O—C(O)—R, wherein R is an alkyl group having 5 carbon atoms or less. In an additional embodiment, the second ligand is acetate or isobutyrate.

In one embodiment, the second ligand volatizes upon heating at a temperature of 200° C. or less. In another embodiment, the second ligand volatizes upon heating at a temperature of 150° C. or less.

In one embodiment, the metal is silver, the first ligand comprises at least two unsubstituted amine groups, and the second ligand is a carboxylate. In one embodiment, the metal complex consist essentially of the metal, the first ligand, and the second ligand.

In one embodiment, the metal complex is selected from

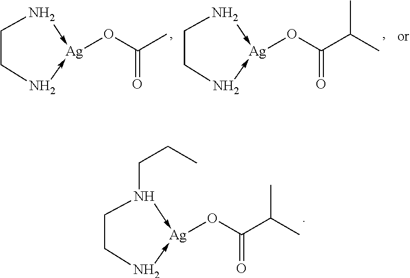

In one embodiment, the composition has a sharp decomposition transition beginning at a temperature of 200° C. or less. In another embodiment, the composition has a sharp decomposition transition beginning at a temperature of 150° C. or less.

In one embodiment, the composition is substantially free of nanoparticles. In one embodiment, the composition can be stored at 25° C. for at least 100 hours without substantial deposition of metal (0).

In one embodiment, the composition comprises at least two metal complexes each comprising a different metal, wherein the at least two metal complexes are adapted to form a metal alloy upon heating.

In one embodiment, the metal complex is represented by formula (II):

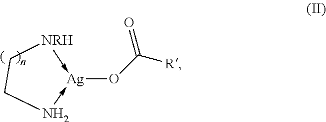

wherein n is an integer of 1 or more, R is H or linear alkane, and R′ is branched, linear or cyclic alkane; wherein the composition further comprises at least one polar protic solvent; and wherein the silver complex has a solubility of at least 250 mg/ml in said polar protic solvent at 25° C.

Another embodiment provides a composition comprising at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex, and wherein the metal complex is represented by formula (I):

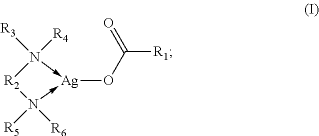

wherein R1 is an optionally substituted alkyl group, R2 is an optionally substituted alkylene group that, together with the Ag and the two amine groups, forms a 4-member, 5-member or 6-member ring, and R3, R4, R5 and R6 are each independently a hydrogen or a polar-terminated alkyl group.

In one embodiment, R1 is linear, branched, or cyclic alkyl group with 5 carbon atoms or less. In another embodiment, R1 is substituted with at least one heteroatom.

In one embodiment, R2 is a linear or branched alkylene group with 5 carbon atoms or less. In another embodiment, R2 is substituted with at least one heteroatom.

In one embodiment, R3, R4, R5 and R6 are each hydrogen. In another embodiment, at least one of R3, R4, R5 and R6 is a polar-terminated alkyl group.

In one embodiment, R1 is methyl or isopropyl, R2 is —CH₂—CH₂—, and R3, R4, R5 and R6 are each hydrogen.

In one embodiment, the composition comprises at least one polar protic solvent. In another embodiment, the composition comprises at least one polar protic solvent, and the metal complex has a solubility of at least 250 mg/ml in the polar protic solvent.

A further embodiment provides a method comprising: depositing an ink on a substrate, wherein the ink comprises a composition described above, and reducing the composition to produce a metallic conductive film.

In one embodiment, the substrate is an organic substrate, and the ink does not react with the organic substrate.

In one embodiment, the ink is substantially free of nanoparticles before deposition. In another embodiment, the ink is substantially free of nanoparticles after deposition.

In one embodiment, the depositing step is carried out by inkjet deposition.

In one embodiment, the reducing step is carried out by heating. In another embodiment, the reducing step is carried out by heating at a temperature of 250° C. or less, 200° C. or less, or 150° C. or less. In a further embodiment, the reducing step is carried out by irradiating.

In one embodiment, the metallic conductive film is in the form of a line, with a conductivity of at least 1,000 S/m, at least 10,000 S/m, or at least 100,000 S/m. In another embodiment, the metallic conductive film is in the form of a line, and the difference between the work function of the metallic conductive film and the work function of the native metal is less than 25%, less than 10%, or less than 5%.

In one embodiment, the metallic conductive film is in the form of a metal grid comprising repetitively patterned structures forming a grid-like network of vertex-shared polygons and polygon-like structures with a varying number of vertices.

Another embodiment provides a composition, comprising: at least one metal complex comprising at least one metal and at least one first ligand and one second ligand, wherein the first ligand is a sigma donor to the metal and volatilizes upon heating the metal complex, and wherein the first ligand is not ammonia, and wherein the second ligand is different from the first ligand and also volatilizes upon heating the metal complex; and wherein the metal complex has a solubility at 25° C. of at least 100 mg/ml in at least one polar protic solvent.

Another embodiment provides a composition comprising at least one composition comprising: (i) at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; (ii) at least one solvent, wherein the solvent is a polar protic solvent. The polar protic solvent, in one embodiment, is an amine compound.

Another embodiment provides for a method of making a composition, the composition comprising: at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and wherein the metal complex has a solubility at 25° C. of at least 100 mg/ml in at least one polar protic solvent, the method comprising reacting a metal complex comprising the metal and the second ligand with the first ligand.

Another embodiment provides for a method, wherein the reducing step of the method comprises at least two heating steps, including a first heating step and a second heating step,

wherein the first heating step is carried out at a first temperature and the second heating step is carried out at a second temperature, and wherein the first temperature is lower than the second temperature.

In one embodiment, the first temperature is about 75° C. to about 200° C. In one embodiment, the first temperature is about 100° C. to about 160° C. In one embodiment, the second temperature is about 200° C. to about 400° C. In one embodiment, the second temperature is about 250° C. to about 350° C. In one embodiment, the first temperature is about 100° C. to about 160° C., and the second temperature is about 250° C. to about 350° C.

In other embodiments, the first heating step is carried out with a first heating time and the second heating step is carried out with a second heating time, and the first heating time is longer than the second heating time. In other embodiments, the first heating step is carried out with a first heating time and the second heating step is carried out with a second heating time, and the first heating time is about 3 minutes to about 20 minutes, and wherein the second heating time is about 30 seconds to about 2 minutes.

In other embodiments, the reducing step of the method comprises only a first heating step in which the temperature and the time of the heating step is adapted to dry the ink but not to produce a full conversion to a final metallic conductive film.

Another embodiment provides for a method comprising: depositing an ink on a substrate, wherein the ink comprises at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and reducing the composition to produce a metallic conductive film, wherein the reducing step comprises at least two heating steps, including a first heating step and a second heating step, wherein the first heating step is carried out at a first temperature and the second heating step is carried out at a second temperature, and wherein the first temperature is lower than the second temperature.

At least one advantage for at least one embodiment is greater versatility in ink use due to the polar character of the solvent. For example, additional substrates can be used. Toxic or carcinogenic organic solvents can be avoided. In addition, in at least some embodiments, higher solute concentrations can be achieved.

At least one additional advantage for at least one embodiment for improved methods of making metallic films, higher conductivities and film qualities can be achieved by use of a first lower temperature heating step followed by the higher temperature heating step. Also, the metal films can be shipped to users after only the first heating step. The user can then if desired apply a fast second heating step.

### DETAILED DESCRIPTION

### Introduction

All references cited herein are incorporated by reference.

Microfabrication, printing, ink jet printing, electrodes, and electronics are described in, for example, Madou, Fundamentals of Microfabrication, The Science of Miniaturization, 2^{nd} Ed., 2002.

Organic chemistry methods and structures are described in, for example, March's Advanced Organic Chemistry, 6^{th} Ed., 2007.

To help enable the growing demands of printing processes and other applications, new metal-containing inks are provided herein for the solution-based deposition of conductive metal films, including coinage metal films, including, for example, silver, gold and copper films. The metallizing ink approach provided herein is based on coordination chemistry and self-reducing ligands that can be, for example, heated or photochemically irradiated to yield metallic films.

Patterning methods including, for example, inkjet printing and aerosol spraying, can be employed to deposit the metal inks in specific, predetermined patterns which can be directly transformed into, for example, circuitry using a laser or simple heating, including low temperature heating.

The versatility of this approach provides printing a variety of designs and patterns on a variety of substrates for much cheaper than conventional deposition methods without the need for lithography.

The compositions and methods described here using polar protic solvent are particular suitable for depositing on organic substrates, for which organic solvents may not be suitable or recommended.

### Metal Complex

The metal complex can be a precursor to a metal film. Metal organic and transition metal compounds, metal complexes, metals, and ligands are described in, for example, Lukehart, Fundamental Transition Metal Organometallic Chemistry, Brooks/Cole, 1985; Cotton and Wilkinson, Advanced Inorganic Chemistry: A Comprehensive Text, 4^{th} Ed., John Wiley, 2000. The metal complex can be homoleptic or heteroleptic. The metal complex can be mononuclear, dinuclear, trinuclear, and of higher nuclearity. The metal complex can be a covalent complex.

The metal complex can be free from metal-carbon bonding.

The metal complex can be as a whole uncharged so there is no counterion which may directly bond to the metal center. For example, in one embodiment, the metal complex is not represented by [M]⁺[A]⁻ wherein the metal complex and its ligands are a cation and anion pair. In one embodiment, the metal complex can be represented by ML₁L₂, wherein M is a metal center, and L₁ and L₂ are first and second metal ligands, respectively. M may have a positive charge which is balanced by a negative charge from L₁ or L₂.

In one embodiment, the metal complex consists essentially of M, L₁ and L₂

The metal complex can be free from anions such as halide, hydroxide, cyanide, nitrite, nitrate, nitroxyl, azide, thiocyanato, isothiocyanato, tetraalkylborate, tetrahaloborate, hexafluorophosphate, triflate, tosylate, sulfate, and/or carbonate.

In one embodiment, the metal complex is free of fluorine atoms, particularly for silver and gold complexes.

The composition comprising the metal complex can be substantially or totally free of particles, microparticles, and nanoparticles. In particular, the composition comprising the metal complex can be substantially or totally free of nanoparticles including metal nanoparticles, or free of colloidal material. See, for example, U.S. Pat. No. 7,348,365 for colloidal approaches to form conductive inks. For example, the level of nanoparticles can be less than 1 wt. %, less than 0.1 wt. %, or less than 0.01 wt. %, or less than 0.001 wt. %. One can examine composition for particles using methods known in the art including, for example, SEM and TEM, spectroscopy including UV-Vis, plasmon resonance, and the like. Nanoparticles can have diameters of, for example, 1 nm to 500 nm, or 1 nm to 100 nm.

The composition comprising the metal complex can be also free of flakes.

The metal complexes can also be adapted for use in forming materials like oxides and sulfides, including ITO and ZnO.

In one embodiment, the metal complex is not an alkoxide.

In one embodiment, the metal complex is hydroscopic and can effectively wet hydrophilic surfaces. In one embodiment, the metal complex does not react with organic substrate.

In one embodiment, the composition comprises at least two different metal complexes, with the same or different metal centers. In another embodiment, the composition comprises at least two different metal complexes each comprising a different metal center, wherein the at least two metal complexes are adapted to form a metal alloy upon heating. Metal alloys and dealloying steps are described in, for example, U.S. provisional application 61/482,571 filed May 4, 2011.

### Metal Center

Metals and transition metals are known in the art. See, for example, Cotton and Wilkinson text, cited above. Coinage metals can be used including silver, gold, and copper. Platinum can be used. Ruthenium can be used. Nickel, cobalt, and palladium can be used. Lead, iron, and tin can be used, for example. Other examples of metals used for conductive electronics are known and can be used as appropriate. Mixtures of metal complexes with different metals can be used. Alloys can be formed.

The metal complex can comprise only one metal center. Or the metal complex can comprise only one or two metal centers.

The metal can be in an oxidation state of (I) or (II).

The metal center can be complexed with first and second ligands. Additional ligands, third, fourth, and the like can be used.

The metal center can be complexed at multiple sites including complexed with three, four, five, or six complexing sites.

The metal center can comprise a metal useful for forming electrically conducting lines, particularly those metals used in the semiconductor and electronics industries.

Still other examples of metals include indium and tin.

In a particular embodiment, the metal center is silver.

### First Ligand

The first ligand can provide sigma electron donation, or dative bonding, to the metal. Sigma donation is known in the art. See, for example, U.S. Pat. No. 6,821,921. The first ligand can be adapted to volatilize when heated without formation of a solid product. The first ligand can volatize upon heating at a temperature of, for example, 250° C. or less, or 200° C. or less, or 150° C. or less. Heating can be done in the presence or absence of oxygen. The first ligand can be a reductant for the metal. The first ligand can be in neutral state, not an anion or a cation.

The first ligand can be a monodentate ligand. The first ligand can also be a polydentate ligand including, for example, a bidentate or a tridentate ligand.

The first ligand can be an amine compound comprising at least two nitrogen. The ligand can be symmetrical or unsymmetrical. The first ligand can be an unsymmetrical amine compound comprising at least two nitrogen.

The first ligand can comprise, for example, at least two amine groups. The first ligand can comprise, for example, at least two unsubstituted amine groups. Unsubstituted amines are stronger reducing agent than alcohols and are capable of forming homogenous solutions with polar protic solvents. Moreover, one or more of the amine groups can be independently substituted with one or more polar groups. Furthermore, the first ligand can comprise, for example, an unsubstituted amine end group and an amine group substituted with a linear alkane.

In one embodiment, the first ligand comprises two primary amine end groups and no secondary amine group. In another embodiment, the first ligand comprises one primary amine end group and one secondary amine end group, wherein the secondary amine end group is substituted with a linear alkane or a polar group. In a further embodiment, the first ligand comprises two primary amine end groups and one secondary amine group.

The first ligand can be, for example, a ligand comprising sulfur, such as tetrahydrothiophene, or an amine. Amine ligands are known in the art. See, for example, Cotton and Wilkinson textbook cited above, page 118.

The first ligand can be an amine including an alkyl amine. The alkyl groups can be linear, branched, or cyclic. Bridging alkylene can be used to link multiple nitrogen together. In the amine, the number of carbon atoms can be, for example, 15 or less, or 10 or less, or 5 or less.

The molecular weight of the first ligand, including an amine, can be, for example, about 1,000 g/mol or less, or about 500 g/mol or less, or about 250 g/mol or less.

In one embodiment, the first ligand is not a phosphine. In one embodiment, the first ligand is not tetrahydrothiophene. In one embodiment, the first ligand does not comprise a ligand comprising sulfur. In one embodiment, the first ligand does not comprise a fluorine-containing ligand.

In a particular example, the first ligand is ethylenediamine.

In one embodiment, the first ligand is not ammonia.

### Second Ligand

The second ligand is different from the first ligand and can volatilizes upon heating the metal complex. For example, it can release carbon dioxide, as well as volatile small organic molecules, in some embodiments. The second ligand can be adapted to volatilize when heated without formation of a solid product. The second ligand can volatize upon heating at a temperature of, for example, 250° C. or less, or 200° C. or less, or 150° C. or less. Heating can be done in the presence or absence of oxygen. The second ligand can be anionic. It can be self-reducing.

The second ligand can be a carboxylate, which is known in the art. See, for example, Cotton and Wilkinson textbook cited above, pages 170-172. Carboxylates including silver carboxylates are known in the art. See, for example, U.S. Pat. Nos. 7,153,635; 7,445,884; 6,991,894; and 7,524,621.

The second ligand can be a carboxylate comprising a hydrocarbon such as, for example, an linear, branched or cyclic alkyl group. In one embodiment, the second ligand does not comprise an aromatic group.

The second ligand can be a carboxylate represented by —O—C(O)—R, wherein R is an alkyl group, wherein R has 10 or fewer carbon atoms, or 5 or fewer carbon atoms. R can be linear, branched or cyclic. The second ligand can be fluorinated if desired including, for example, comprise trifluoromethyl groups. In one embodiment, the second ligand is not a fatty acid carboxylate. The second ligand can be an aliphatic carboxylate. The second ligand can be not a formate ligand.

The second ligand can be an amide represented by —N(H)—C(O)—R, wherein R is a linear, branched or cyclic alkyl group, with 10 or fewer carbon atoms, or 5 or fewer carbon atoms. The second ligand can also be an N-containing bidentate chelator.

The molecular weight of the second ligand, including the carboxylate, can be, for example, about 1,000 g/mol or less, or about 500 g/mol or less, or about 250 g/mol, or about 150 g/mol or less or less.

In one embodiment, the second ligand does not comprise a fluorine-containing ligand.

In a particular embodiment, the second ligand is acetate or isobutyrate.

In one embodiment, the second ligand is not a carbamate or a carbonate.

### Solubility in Polar Protic Solvent

The metal complex described here is soluble in at least one polar protic solvent. Polar protic solvents are known in the art and described in, for example, Loudon, Organic Chemistry, 4^{th} Ed., New York: Oxford University Press, 2002, which is incorporated herein by reference in its entirety. In general, polar protic solvents can have high polarity and high dielectric constant. Polar protic solvents can comprise, for example, at least one hydrogen atom bound to an oxygen or a nitrogen. Polar protic solvents can comprise, for example, at least one acidic hydrogen. Polar protic solvents can comprise, for example, at least one unshared electron pair. Polar protic solvents can display, for example, hydrogen bonding.

The viscosity of hydrogen bonding solvents is inherently greater than non-hydrogen bonding solvents, and thus more amenable to inkjet printing. Further the elevated solvent boiling points (due to energetically greater intermolecular forces) and polar ink nature render them capable and competent systems for the formation of thin films and structures of greater quality than strictly hydrocarbon or aromatic hydrocarbon delivery systems due to slower controlled drying times, surface tensions, and surface wetting properties.

Examples of polar protic solvent include water, linear or breached alcohols, and hydroxyl-terminated polyols including glycols. The polar protic solvent can also be, for example, ethylene and higher glycols, as well as unsymmetrical alcohols. Particular examples of solvent include water, methanol, ethanol, n-propanol, isopropanol, n-butanol, acetic acid, formic acid, ammonia, and PEG (poly(ethylene glycol)). Forms of PEG which have lower molecular weight and function as liquids and/or solvents can be used. For example, the PEG molecular weight can be 500 g/mol or less, or 400 g/mol or less, or 300 g/mol or less.

Metal complexes soluble in polar protic solvents are particularly useful for depositing on an organic substrate, since organic solvent may not be recommended in such situations.

The metal complexes described here can have a solubility in at least one polar protic solvent at 25° C. of at least 50 mg/ml, 100 mg/ml, or at least 150 mg/ml, or at least 200 mg/ml, or at least 250 mg/ml, or at least 300 mg/ml, or at least 400 mg/ml, or at least 500 mg/ml. For example, the metal complexes can have a solubility in water at 25° C. of at least 50 mg/ml, at least 100 mg/ml, or at least 150 mg/ml, or at least 200 mg/ml, or at least 250 mg/ml, or at least 300 mg/ml, or at least 400 mg/ml, or at least 500 mg/ml. Moreover, the metal complexes can have a solubility in ethanol at 25° C. of at least at least 50 mg/ml, 100 mg/ml, or at least 150 mg/ml, or at least 200 mg/ml, or at least 250 mg/ml, or at least 300 mg/ml, or at least 400 mg/ml, or at least 500 mg/ml. Furthermore, the metal complexes can have a solubility in PEG at 25° C. of at least at least 50 mg/ml, 100 mg/ml, or at least 150 mg/ml, or at least 200 mg/ml, or at least 250 mg/ml, or at least 300 mg/ml, or at least 400 mg/ml, or at least 500 mg/ml.

In one embodiment, the composition is substantially or totally free of organic solvent. The amount of organic solvent can be, for example, less than 30 wt. %, less than 20 wt. %, less than 10 wt. %, less than 5 wt. %, less than 3 wt. %, less than 1 wt. %, less than 0.1 wt. % or less than 0.01 wt. %.

The polar protic solvent can include, for example, at least one amine solvent. The amine solvent can have a molecular weight of, for example, about 200 g/mol or less, or about 100 g/mol or less. The amine solvent can be, for example, at least one monodentate amine, at least one bidentate amine, and/or at least one polydentate amine. The amine solvent can be, for example, at least one primary amine or at least one secondary amine. In one embodiment, the amine solvent comprise at least one alkyl group bonded to at least one primary or secondary amine. In one particular embodiment, the amine solvent comprises at least two primary or secondary amine groups connected by a linear or branched alkyl group. In another particular embodiment, the amine solvent comprises at least two linear or branched alkyl groups connected by at least one secondary amine. Examples of the amine solvent include, for example, N,N-dimethylethylenediamine. Advantages of the amine solvent include, for example, improved solubility and thus higher concentration of the metal complex.

### Mixed Solvent System

The metal complex described here can also be used in a mixed solvent system. The mixed solvent system can comprise, for example, two or more polar protic solvents. In one embodiment, a range of ethylene glycol to small monoprotic PEG from 1:9 to 9:1 can be used. In another embodiment, a range of ethylene glycol to small monoprotic PEG from 1:19 to 19:1 can be used. In a further embodiment, a range of ethylene glycol to small monoprotic PEG from 1:99 to 99:1 can be used. Other PEG mixture can also be used.

The mixed solvent system can also comprise at least one amine solvent. The volume percentage of amine solvent in the mixed solvent system can be, for example, about 30% to about 70%, or about 10% to about 90%, or about 5% to about 95%, or about 1% to about 99%.

### Characteristics of the Metal Complexes

The metal complex can have a sharp decomposition transition beginning at a temperature of less than 250° C., or less than 200° C., or less than 150° C., or less than 120° C.

The metal complex composition can be stored at about 25° C. for at least 100 hours, or at least 250 hours, or at least 500 hours, or at least 1,000 hours, or at least six months, without substantial deposition of metal (O). This storage can be neat or in a solvent. The composition can be stored at lower temperatures such as, for example, less than 25° C. to provide longer stability. For example, some composition can be stored at 0° C. for very long periods of time including, for example, at least 30 days, or at least 90 days, or at least 365 days. Alternatively, for example, some composition can be stored at −35° C. or lower for very long periods of time including, for example, at least 30 days, or at least 90 days, or at least 365 days.

The metal complexes can comprise, for example, at least 25 wt. % metal, or at least 50 wt. % metal, or at least 60 wt. % metal, or at least 70 wt. % metal. This provides for efficient use of metal and good conductivity upon conversion to metal.

The metal complexes can be adapted to provide sufficient stability to be commercially useful, but also sufficiently reactive to provide low cost, high quality products. One skilled in the art can adapt the first and second ligands to achieve a balance needed for a particular application.

### Methods of Making Compositions

Metal complexes can be made by a variety of methods including those described in US 2011/0111138, incorporated by reference in its entirety. In one embodiment, metal or silver carboxylate complexes are prepared by reacting the metal or silver carboxylate acetate with an carboxylic acid so that an exchange reaction occurs to form a new metal or silver carboxylate complex. See, for example, reaction (1) in Example 1, wherein R can be, for example, an alkyl group including a linear, branched, or cyclic alkyl, including for example an alkyl group with ten or fewer, or five or fewer carbon atoms. The yield of reaction can be, for example, at least 50%, or at least 70%, or at least 90%.

In one embodiment, the metal or silver carboxylate complex is made without use of metal oxide including Ag₂O. See, for example, comparative reaction (2) in Example 1. In one embodiment, the metal or silver carboxylate is made without use of a solid state reaction.

In one embodiment, gold complexes are prepared by reaction of a gold chloride complex, which is also complexed with a sigma donor such as tetrahydrothiophene or a phosphine, with a silver carboxylate complex. The result is precipitation of silver chloride. See e.g., reaction (5) below.

In one embodiment, metal complexes are prepared by exchanging dative bonding ligands such as the first ligands. For example, tetrahydrothiophene can be exchanged for an amine. See e.g., reaction (6) below.

In some embodiments, metal complexes described here can be prepared according to the following exemplary reactions (3) and (4) (R is a linear, branched or cyclic alkyl group). The stoichiometric ratio between the amine compound and the silver carboxylate can be, for example, at least 13:1, or at least 15:1, or at least 20:1. The resulting metal complexes are soluble in a polar protic solvent such as ethanol or water through H-bond interactions between the ligand and the polar protic solvent.

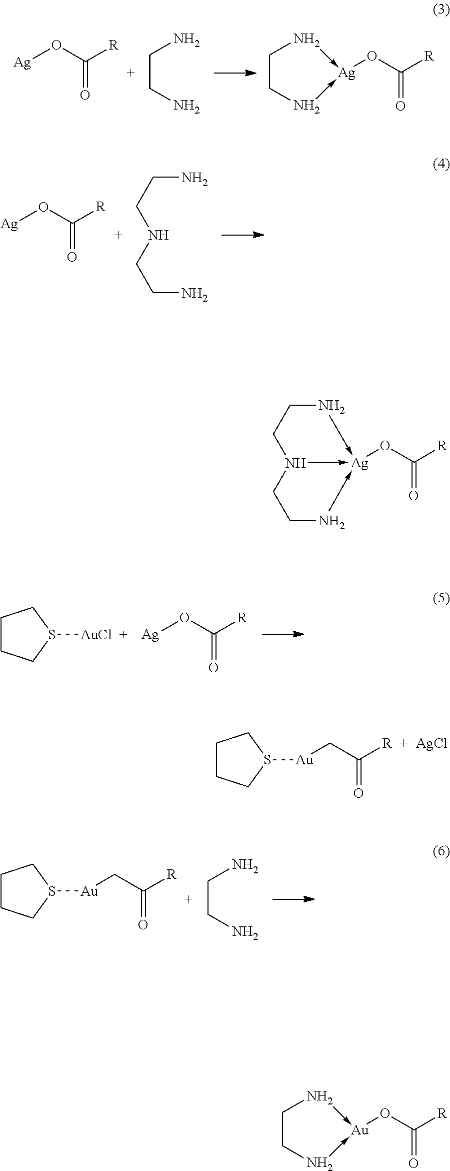

### Deposition of Ink

Methods known in the art can be used to deposit inks including, for example, spin coating, pipetting, inkjet printing, blade coating, rod coating, dip coating, lithography or offset printing, gravure, flexography, screen printing, offset printing, flexo printing, stencil printing, drop casting, slot die, roll-to-roll, stamping, roll coating, spray coating, flow coating, and aerosol delivery such as spraying. One can adapt the ink formulation and the substrate with the deposition method. See also Direct Write Technologies book cited above. For example, chapter 7 describes inkjet printing. Contact and non-contact deposition can be used. Vacuum deposition may not be used. Liquid deposition can be used. Coating and printing can be carried out.

One can adapt the viscosity of the ink to the deposition method. For example, viscosity can be adapted for ink jet printing. Viscosity can be, for example, about 500 Cps or less. Or viscosity can be, for example, 1,000 Cps or more. In a particular embodiment, the ink does not comprise any solid material. Alternatively, one can adapt the concentration of solids in the ink. The concentration of the solids in the ink can be, for example, about 500 mg/mL or less, or about 250 mg/mL or less, or about 100 mg/mL or less, or about 150 mg/mL or less, or about 100 mg/mL or less. A lower amount can be, for example, about 1 mg/mL or more, or about 10 mg/mL or more. Ranges can be formulated with these upper and lower embodiments including, for example, about 1 mg/mL to about 500 mg/mL. In addition, the wetting properties of the ink can be adapted.

Additives such as, for example, surfactants, dispersants, and/or binders can be used to control one or more ink properties if desired. In one embodiment, an additive is not used. In one embodiment, a surfactant is not used.

Nozzles can be used to deposit the precursor, and nozzle diameter can be, for example, less than 100 microns, or less than 50 microns. The absence of particulates can help with prevention of nozzle clogging.

In deposition, solvent can be removed, and the initial steps for converting metal precursor to metal can be started.

### Substrates

A wide variety of solid materials can be subjected to deposition of the metal inks Polymers, plastics, metals, ceramics, glasses, silicon, semiconductors, and other solids can be used. Organic and inorganic substrates can be used. Polyester types of substrates can be used. Paper substrates can be used. Printed circuit boards can be used. Substrates used in applications described herein can be used.

Substrates can comprise electrodes and other structures including conductive or semiconductive structures.

In a particular embodiment, the substrate is an organic substrate such as kapton or PET.

### Converting Ink to Metal

The inks and compositions comprising metal complexes can be deposited and converted to metallic structures including conductive metal films. Lines, dots, circles, and vertex-shared polygons can be formed. The ink can be reduced to a conductive metal film by heating or irradiating. Laser light can be used. The atmosphere around the metal film can be controlled. For example, oxygen can be included or excluded. Volatile by-products can be eliminated.

The reduction of the metal can also be carried out at room temperature with a reactive gas. Examples of suitable reactive gas include hydrazine forming gas such as H2/N2.

The ink can be, for example, substantially or totally free of nanoparticles before deposition. The ink can be, for example, substantially or totally free of nanoparticles after deposition but before reduction to metal. The ink can be, for example, substantially or totally free of nanoparticles after deposition and reduction to metal.

The reduction process can be carried out by heating at a temperature of, for example, 250° C. or less, or 200° C. or less, or 150° C. or less, or 120° C. or less, or 100° C. or less. The conductive metal film obtained can have a conductivity of, for example, at least 1,000 S/m, or at least 10,000 S/m, or at least 100,000 S/m, or at least 200,000 S/m, or at least 500,000 S/m, or at least 10⁶ S/m.

Metallic Lines after Deposition and Curing

The metallic lines and films can be coherent and continuous. Continuous metallization can be observed with good connectivity between grains and low surface roughness.

The thickness of the metallic lines and the films can be 1000 nm or less, or 500 nm or less, or 250 nm or less, or 100 nm or less.

Line width can be, for example, 1 micron to 500 microns, or 5 microns to 300 microns. Line width can be less than one micron if nanoscale patterning methods are used.

Dots, circles, and vertex-shared polygons can be also made.

In one embodiment, ink formulations can be converted to metallic lines and films without formation of substantial amounts of metal particles, microparticles, or nanoparticles.

Metal lines and films can be prepared with characteristics of metal and lines prepared by other methods like sputtering.

Metal lines and films can be, for example, at least 90 wt. % metal, or at least 95 wt. % metal, or at least 98 wt. % metal.

Metal lines and films can be relative smooth (e.g., <8 nm) according to AFM measurements.

Metal lines and films can be used to join structures such as electrodes or other conductive structures.

The metal lines and films obtained according to methods described here can have a work function which is substantially the same as a native metal work function. For example, the difference can be 25% or less, or 10% or less, or 5% or less.

Lines and grids can be formed. Multi-layer and multi-component metal features can be prepared.

### Applications

Deposition and patterning by direct-write methods, including inkjet printing, is described in, for example, Pique, Chrisey (Eds.), Direct-Write Technologies for Rapid Prototyping Applications, Sensors, Electronics, and Integrated Power Sources, Academic Press, 2002.

One application is forming semiconductor devices including transistors and field effect transistors. Transistors can comprise organic components including conjugated or conductive polymers.

Applications include electronics, printed electronics, flexible electronics, solar cells including inverted solar cells, displays, screens, light weight devices, LEDs, OLEDs, organic electronic devices, catalysis, fuel cells, RFID, and biomedical.

The deposited metal can be used as a seed layer for use with, for example, subsequent electroplating.

Other technology applications are described in, for example, “Flexible Electronics” by B. D. Gates, Science, vol 323, Mar. 20, 2009, 1566-1567 including 2D and 3D applications.

Examples of patent literature describing methods and applications include, for example, US patent publications 2008/0305268; 2010/0163810; 2006/0130700; and U.S. Pat. Nos. 7,014,979; 7,629,017; 6,951,666; 6,818,783; 6,830,778; 6,036,889; 5,882,722.

### Metal Grid

The inks and metal complex compositions described here can be adapted for the ITO replacement structures including metal grid. See, for example, U.S. provisional application 61/553,048 filed Oct. 28, 2011. Single metal structures or multiple-metal structures, including alloys, can be made.

Repetitively patterned structures, including “grid” and “micro-grid”, are known in the art and described in, for example, Neyts et al., J. Appl. Phys. 103:093113 (2008), Cheknane, Prog. Photovolt: Res. Appl. 19:155-159 (2011), Layani et al., ACSNANO 3(11):3537-3542 (2009), U.S. Pat. No. 6,831,407 and US 2008/0238310, all of which are incorporated herein by reference in their entireties.

The repetitively patterned structure can form grid-like network of vertex-shared polygons and polygon-like structures with a varying number of vertices.

The repetitively patterned structure can be of any geometry, which includes, for example, triangular geometry, rectangular geometry, hexagonal geometry, and overlapping circular geometry described in Neyts et al., J. Appl. Phys. 103:093113 (2008); Cheknane, Prog. Photovolt: Res. Appl. 19:155-159 (2011), U.S. Pat. No. 6,831,407 and US 2008/0238310; and Layani et al., ACSNANO 3(11):3537-3542 (2009).

The respectively pattern structure can comprise, for example, lines and/or holes. The apothem of the holes can be, for example, about 100-100,000 microns, or about 1000-10,000 microns. The width of the lines can be, for example, about 100-10,000 microns, or about 500-2,000 microns. The depth of the lines can be, for example, 1-100 microns, or 1-20 microns, or 1-10 microns, or 1-5 microns, or less than 1 microns, or less than 100 nm.

The repetitively patterned structure can allow, for example, at least 50% if photons to pass through, or at least 80% of photons to pass through, or at least 85% of photons to pass through, or at least 90% of photons to pass through, or at least 95% of photons to pass through, or at least 97% of photons to pass through, or at least 98% of photons to pass through, or at least 99% of photons to pass through.

The repetitively patterned structure can be formed on, for example, a rigid substrate such as glass or a flexible organic substrate, including polymer substrates.

The repetitively patterned structure can have many applications. The repetitively patterned structure can be incorporated in, for example, high impedance electrodes. The repetitively patterned structure can be incorporated in, for example, waveguides or reflectors of all types. The wavelength of electromagnetic radiation to be harnessed and manipulated by metallic patterns can determine the aperture spacing and line width.

The repetitively patterned structure can also be incorporated in, for example, biosensors. Metallic patterns with high surface area are capable of immobilizing lock and key analyte detection which could be analyzed by optical changes in the grid or passed radiation.

The repetitively patterned structure can be incorporated in, for example, plasmonic resonators. An optical gain device can be made similar to a lazing cavity if the grids were stacked atop each other or the incident radiation was passed horizontally through the grid. Moreover, the repetitively patterned structure can be used in a Mach-Zehnder interferometer. Furthermore, the repetitively patterned structure can be made of inert material and have a high surface area, and wherein the repetitively patterned structure is adapted for a flow-through heterogeneous catalyst support.

Transparency and electronic conductivity of the structures can be measured.

Applications are many and include touch-screens, including resistive, capacitive, and other kinds of touch-screens.

### Additional Embodiments of Silver Complexes

The metal complexes described here include self-reducing silver complexes that are soluble in polar protic solvents and that metalize at low temperatures (<200° C.). These silver complexes form hydrogen bonds with solvent to produce homogeneous metal inks based on donor-acceptor proton interactions.

In a particular embodiment, the metal complex described here is a silver complex. The silver complex can be a metal-organic compound represented by formula (I):

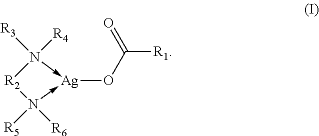

R1 can be, for example, an optionally substituted linear, branched or cyclic alkyl group. R1 can be, for example, substituted with at least one heteroatom. R1 can comprise, for example, 10 carbon atom or less, or 5 carbon atoms or less, or 4 carbon atoms or less, or 3 carbon atoms or less. Particular examples of R1 include methyl and isobutyl.

R2 can be, for example, an optionally substituted linear, branched or cyclic alkylene group. R2 can be, for example, substituted with at least one heteroatom. R2 can comprise, for example, 5 carbon atoms or less, or 4 carbon atoms or less, or 3 carbon atoms or less, or 2 carbon atoms or less. R2 can form a ring with Ag and the two amine groups. Said ring can be a 4-member ring, a 5-member ring or a 6-member ring. Particular examples of R2 include “—CH2-CH2-” and “—CH2-CH2-CH2—”.

R3, R4, R5 and R6 can be, for example, independently a hydrogen, a polar group such as a poly-terminated alkyl, or a linear alkane. In one embodiment, R3, R4, R5 and R6 are each hydrogen. In another embodiment, R3, R4, R5 and R6 are each a polar substituent group. In a further embodiment, one of R3, R4, R5 and R6 is a polar substituent group or a linear alkane, and the other three are hydrogen. In a yet another embodiment, two of R3, R4, R5 and R6 are polar substituent groups, and the other two are hydrogen. In yet a further embodiment, one of R3 and R4 is a polar substituent group, and one of R5 and R6 is a polar substituent group.

The silver complex can be soluble in at least one polar protic solvent. The silver complex can have a solubility of 50 mg/ml or more, or 100 mg/ml or more, or 150 mg/ml or more, or 200 mg/ml or more, or 250 mg/ml or more, or 500 mg/ml or more, at 25° C. in water, ethanol, glycol, PEG, or any mixture thereof.

In a particular embodiment, the polar protic soluble silver complex is represented by formula (II):

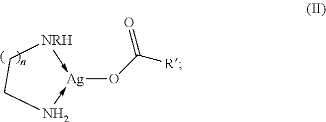

wherein n is an integer of 1 or more; R is H or linear alkane; and R′ is branched, linear or cyclic alkane.

R can be, for example, 10 carbon atoms or less, or 5 carbon atoms or less, or 3 carbon atoms or less. R can be, for example, methyl, ethyl, n-propyl, n-butyl.

R′ can be, for example, an optionally substituted linear, branched or cyclic alkane. R1 can comprise, for example, 10 carbon atom or less, or 5 carbon atoms or less, or 4 carbon atoms or less, or 3 carbon atoms or less. Particular examples of R′ include methyl and isobutyl.

n can be, for example, 5 or less, or 4 or less, or 3 or less, or 2 or less.

### Additional Embodiments Using Low Temperature and High Temperature Heating

In other embodiments, the method of converting the deposited film to a final film is improved. Another embodiment provides for a method comprising: depositing an ink on a substrate, wherein the ink comprises at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and reducing the composition to produce a metallic conductive film, wherein the reducing step comprises at least two heating steps, including a first heating step and a second heating step, wherein the first heating step is carried out at a first temperature and the second heating step is carried out at a second temperature, and wherein the first temperature is lower than the second temperature. Third and fourth and more heating steps can be used if desired. In many embodiments, only two heating steps are needed so the process can consist of or consist essentially of only two heating steps.

Inks used in the methods with multiple heating steps are described above and also in, for example, US Patent Publications 2011/0111138 and 2012/0304889 to Belot et al.

Another embodiment provides for a method, wherein the reducing step as described above of the method comprises at least two heating steps, including a first heating step and a second heating step, wherein the first heating step is carried out at a first temperature and the second heating step is carried out at a second temperature, and wherein the first temperature is lower than the second temperature. The difference between the first temperature and the second temperature can be, for example, at least 50° C., or at least 100° C., or at least 150° C.

The first temperature can be a fixed temperature used throughout the first heating step, or the first temperature can be varied or can vary throughout the first heating step within a range. For example, in the first heating step, the temperature range could be 120° C. to 140° C. Temperature variation can be deliberate or programmed. Temperature variation can also reflect experimental variance. Similarly, the second temperature can be a fixed temperature used throughout the second heating step, or the second temperature can be varied or can vary throughout the second heating step within ranges. In many embodiments, the first temperature and the second temperature are fixed temperatures, or at least fixed within experimental error.

In one embodiment, the first temperature is about 75° C. to about 200° C. In one embodiment, the first temperature is about 100° C. to about 160° C. In one embodiment, the second temperature is about 200° C. to about 400° C. In one embodiment, the second temperature is about 250° C. to about 350° C. In one embodiment, the first temperature is about 100° C. to about 160° C., and the second temperature is about 250° C. to about 350° C.

In other embodiments, the first heating step is carried out with a first heating time and the second heating step is carried out with a second heating time, and the first heating time is longer than the second heating time. In other embodiments, the first heating step is carried out with a first heating time and the second heating step is carried out with a second heating time, and the first heating time is about 3 minutes to about 20 minutes, and wherein the second heating time is about 30 seconds to about 2 minutes.

In other embodiments, the reducing step of the method comprises only a first heating step in which the temperature and the time of the heating step is adapted to dry the ink but not to produce a full conversion to a final metallic conductive film. This allows one party to do the first heating step and then to ship the partially baked film to another party who can execute a final cure step.

Film thickness can be, for example, 5 nm to 85 nm, or 10 nm to 50 nm, or 25 nm to 35 nm. The heating temperatures and times for the multiple steps can be adapted for the thickness. For example, for relatively thinner films (e.g., less than 25 nm), the first heating step could be carried out at a relatively higher temperature. In another example, for relatively thicker films (e.g., thicker than 35 nm), the second heating step could be carried out with relatively longer times or higher temperatures Ink solid concentration can be used to tailor film thickness. Thicker films can be prepared with use of more highly concentrated inks (e.g., 200 mg/mL rather than 100 mg/mL). Thinner films can be prepared with use of less highly concentrated inks

The conductivity of the thin metal film (e.g., silver film) can be compared to the conductivity of the bulk metal (e.g., bulk silver), and the two conductivities can be compared. The films can have, for example, 20% to 50%, or 30% to 40% of the conductivity of the bulk metal.

For methods using multiple heat treatment steps, the solvent can be, for example, isopropanol.

Additional embodiments are provided in the following non-limiting working examples.

### Working Example 1

### Silver Carboxylate Precursors

Two silver carboxylate compounds were prepared for use as precursors to inventive complexes. See, for example, US Patent Publication 2011/0111138. For their synthesis, a known method based on Ag₂O (reaction 2 below) was compared to a cleaner, cheaper method based on silver acetate (reaction 1 below). These are shown below, and two exemplary R groups are shown. The Ag₂O method (reaction 2) relied on a solid state reaction, failed to go to completion, and did not yield analytically pure materials. In contrast, the metathesis reaction between a carboxylic acid and silver acetate (reaction 1) went to completion, afforded analytically pure compounds, and proceeded in quantitative yields. The elemental analysis of the two silver complexes from this reaction (1) were C, 24.59; H, 3.72 and C, 24.68; H, 2.56 for the isobutyrate and cyclopropate, respectively. Theoretical values are C, 24.64; H, 3.62 and C, 24.90; H, 2.61 for the isobutyrate and cyclopropate, respectively. Thus, approach (1) was superior to (2).

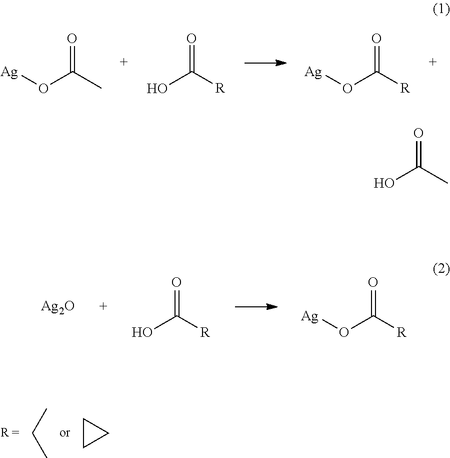

From the silver complexes, libraries of Ag-carboxylate amine compounds could be prepared that are viable for the production of metallic silver films, lines, and structures.

### Working Example 2

### Preparation of Ethylenediamine Silver Isobutyrate Ink

In a typical preparation 1.0 g silver isobutyrate was prepared according to Example 1 and was placed in a 25 mL one-neck 14/20 round bottom flask containing a Teflon coated magnetic stir bar. To this was added 13 eq. ethylene diamine. The reaction proceeded for 2 h with stirring after which time the organics were removed in vacuo to yield a grey to colorless deliquescent solid (ethylenediamine silver isobutyrate). The structure is shown below:

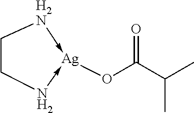

The compound is 42.29 wt. % metal. It is soluble in ethanol and water. The compound was hydroscopic

### Working Example 3

### Preparation of Inks

This solid ink precursor from example 2 was then dissolved in a polar protic solvent (e.g., ethanol) in concentrations that ranged up to 500 mg/mL in 100 mg/mL increments. Inks at 250 mg/mL were also made.

### Working Example 4

### Preparation and Characterization of Films

Initial metallization was tested via drop casting the ink and then heating on an aluminum block at about 145° C.

In Example 4A, the ink (with ethanol as solvent) was deposited onto an untreated glass coverslips via spin coating at RPMs between 500-1000 rpm for 10-30 seconds. The coverslips were then metalized on an aluminum block.

The sheet resistance was taken using a 4 pt. probe and the thickness determined via profilometry or cross-sectional electron microscope. The films were heated at 160° C. for 10 min.

In Example 4B, the ink (with ethanol as solvent) was allowed to pump longer and was believed to be drier. Similar glass coverslips and experimental parameters as used in Example 4A were used and the conductivity was improved. The films were heated at 160° C. for 10 min.

In Example 4C, a separate polar solvent (propylene glycol butyl ether) was used and the ink solution was deposited onto a glass slide via spin coating. The sample was heated at 145° C. for 10 minutes.

Table 1 lists the data gathered for Examples 4A, 4B, and 4C.

TABLE 1

| | Thickness | Sheet Resistance | Conductivity |
|---|---|---|---|
| | (Å) | (Ω/□) | (S/m) |
| Example 4A | 500-1500 | 5-8 | 10⁴-10⁵ |
| Example 4B | 700-1500 | 2-5 | 10⁵-10⁶ |
| Example 4C | 230 | 2 | 4 × 10⁶ |

### Working Example 5

### Metal Grid Study

Ethylene diamine silver ink in ethanol was made at a concentration of 250 mg/mL. Spin coating was carried out with dwell time of 30 seconds with varying RPMs on glass coverslips. Metallization was carried out at 160° C. for 10 minutes. In some cases, samples with two coats were created by immediately applying a second layer of ink and spin coating with no processing in between layer application.

Table 2 shows the results.

TABLE 2

| Sam- | Average | Average Sheet | Conductivity | Spin Speed | |
|---|---|---|---|---|---|
| ple | Thickness (m) | Resistance (Ω/□) | (S/m) | (RPM) | Coats |
| 5-A | 1.74E−07 | 2.73 | 4.64E+05 | 500 | 1 |
| 5-B | 1.69E−07 | 2.42 | 5.38E+05 | 500 | 2 |
| 5-C | 8.73E−08 | 2.76 | 9.17E+05 | 1000 | 1 |
| 5-D | 8.79E−08 | 2.40 | 1.05E+06 | 1000 | 2 |
| 5-E | 7.55E−08 | 3.04 | 9.62E+05 | 1000 | 1 |
| 5-F | 9.56E−08 | 4.61 | 5.01E+05 | 1000 | 2 |

NOTE:
In examples 5-E and 5-F, glass slides were dried in the oven and cooled in a desiccator
prior to the spin coating of ink.

### Working Example 6

### Ethylenediamine Silver Acetate

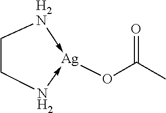

This compound was also prepared. The carboxylate metathesis was not needed due to the commercial availability of silver acetate. The metal content was 47.52 wt. %. It was soluble in ethanol and water. The compound was extremely hydroscopic.

### Working Example 7

### Mixed Solvent System

### Materials

### Glass Slides (1 in.×1 in.)

Propylene glycol butyl ether
Ethylene glycol
Ethylene diamine silver isobutyrate ink

### Experimental

In a first experiment, a solution of 90% propylene glycol butyl ether and 10% ethylene glycol (v:v) was made and these components led to a homogeneous, completely miscible, mixture. This solution was then used to make a 350 mg/mL solution of ethylene diamine silver isobutyrate ink. An untreated glass slide was then spin coated with this ink and was metalized at 160° C. for 30 min. yielding a shiny metallic film.

In a second experiment, a solution of 95% propylene glycol butyl ether and 5% ethylene glycol (v:v) was made and these components led to a homogeneous, completely miscible, mixture. This solution was then used to make a 250 mg/mL solution of ethylene diamine silver isobutyrate ink. An untreated glass slide was then spin coated and metalized at 145° C. for 10 min yielding a shiny metallic film.

### Results

Using a mixed PEG solvent system incorporating ethylene glycol enabled a concentration increase of the ethylene diamine silver isobutyrate ink (due to the ink's excellent solubility in this solvent, while still maintaining the coating properties of the majority solvent, propylene glycol butyl ether. Concentrations varied with the amount of ethylene glycol that was used; i.e., the greater the volume percentage of ethylene glycol the more silver complex would dissolve. In addition, the propensity of ink crystallization or dissolution was greatly diminished affording an ink with a greater longevity.

### 1^{st} Experiment Results

| Sheet Resistance | Thickness | Conductivity |
|---|---|---|
| (Ω/□) | (nm) | (S/m) |
| 1.06 | 203.73 | 1.02E+06 |

### 2^{nd} Experiment 2 Results

| Sheet Resistance | Thickness | Conductivity |
|---|---|---|
| (Ω/□) | (nm) | (S/m) |
| 1.73 | 84.7 | 1.50E+06 |

### Working Example 8

### Amine Solvent

### Experimental

### Example 8A

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 800 RPM for 5 seconds. The sample was metalized for 10 minutes at 147° C.

### Example 8B

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 800 RPM for 5 seconds. The sample was metalized for 10 minutes at 147° C.

After the sheet resistance was taken, a second layer was added via spin coating at 800 RPM for 5 seconds. The sample was then metalized for another 10 minutes.

### Example 8C

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 800 RPM for 5 seconds. The sample was metalized for 20 minutes at 147° C.

### Example 8D

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 800 RPM for 5 seconds. The sample was metalized for 1 minute at 147° C.

A second layer was added via spin coating at 800 RPM for 5 seconds. The sample was then metalized for another 10 minutes.

### Example 8E

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 800 RPM for 5 seconds. The sample was metalized for 1 minute at 147° C.

A second layer was added via spin coating at 800 RPM for 5 seconds. The sample was then metalized for another 1 minute.

A third layer was added via spin coating at 800 RPM for 5 seconds, and the entire sample was metalized for 10 minutes.

### Example 8F

A 250 mg/mL solution of ethylene diamine silver isobutyrate ink in a solvent system of 50% propylene glycol butyl ether and 50% N,N-dimethylethylenediamine (v:v) was made. The solution was deposited via spin coating at 1000 RPM for 5 seconds. The sample was metalized for 30 seconds at 147° C.

A second layer was added via spin coating at 1000 RPM for 5 seconds. The sample was then metalized for another 30 seconds.

A third layer was added via spin coating at 1000 RPM for 5 seconds, and the entire sample was metalized for 10 minutes.

### Results

### Example 8A Data

| (Ω/□) | nm | Conductivity (S/m) |
|---|---|---|
| 4.6157 | 94 | |
| 5.8504 | 102 | |
| 14.4823 | 120 | 2.52E+05 |

### Example 8B Data

| (Ω/□) | nm | Conductivity (S/m) |
|---|---|---|
| 0.6744 | 220 | |
| 0.62817 | 215 | |
| 0.65273 | 206 | 1.59E+06 |

### Example 8C Data

| (Ω/□) | nm | Conductivity (S/m) |
|---|---|---|
| 3.5438 | 130 | |
| 4.8693 | 117 | |
| 3.7734 | 151 | 4.10E+05 |

### Example 8D Data

| (Ω/□) | nm | Conductivity (S/m) |
|---|---|---|
| 1.1328 | 252 | |
| 1.1132 | 263 | |
| 1.0228 | 273 | 7.71E+05 |

### Example 8E Data

| (Ω/□) | nm | Conductivity (S/m) |
|---|---|---|
| 0.532 | 328 | |
| 0.205 | 426 | |
| 0.237 | 391 | 1.78E+06 |

### Example 8F Data

| (Ω/□) | nm | Conductivity (S/m) |
|---|---|---|
| 1.0495 | 327 | |
| 0.95749 | 308 | |
| 0.31285 | 315 | 9.01E+05 |

### Working Example 9

A new processing procedure was used for silver ink sets. This procedure involved pre-baking the deposited metallic ink at a low temperature, followed by a relatively brief, high temperature curing step. It was shown that utilizing a pre-bake step improves the final conductivity after baking at higher temperatures. Using a pre-bake step enables one to send pre-deposited metallic features as samples to users interested in applying rapid cure technology to the inks

This example was designed to discover whether the pre-baked at 130° C. for 10 minutes before the final cure at 300° C. for 1 minute, achieved the same conductivity as samples that are just cured at 300° C.

### Materials

1″×1″ glass slides, dried in an oven and cooled in a desiccator
5 mL ethylenediamine silver isobutyrate in IPA @ 100 mg/mL (IPA is isopropyl alcohol)
Pipettes
Syringe Filter Discs
Spin Coater

### Methods

Ink was deposited via spin-coater using a recipe of 800 RPM with a 5 s dwell time and a dry step of 120 RPM with a dwell time of 10 s. One set of slides slides were pre-baked at 130° C. for 10 min, then cured at 300 for 1 minute. A second set of samples were cured at 350° C. for 5, 20, 25, and 30 seconds. The samples that were cured at 350° C. without a pre-bake saw decreased sheet resistance, and increased appearance of oxidation. The sheet resistances on the samples were measured via 4 point probe. The thicknesses of these samples were then collected via profilometry.

Visually, samples with no pre-bake step appeared to have a higher amount of oxidation (samples were white/silver). The samples that were pre-baked samples were more silver in color. It is assumed that because of the longer the time at 350° C., the thinner the film because of oxidation.

The samples that were made omitting the pre-bake appeared to be less adhesive to glass. The films could be easily rubbed off of the glass, compared to the samples that included the pre-bake. This also caused difficulty when taking the profilometer measurements due to scratching

After a pre-bake of 130° C. for 10 minutes, the samples cured at 300° C. for 1 minute seemed to have higher conductivity than the samples without a pre-bake. A cure time of 1 minute at 300° C. had 35-39% bulk Ag, compared to a peak of 33% bulk Ag at 350° C. for 20 seconds.

Additional experiments were carried out to determine parameters such as best heating times, heating temperatures, and film thicknesses.

An aging study was also carried out. In one set of samples, the films were pre-baked at 130° C. for ten minutes and then cured at 300° C. for one minute. Another set of samples were treated substantially the same but were aged in ambient for one week or two weeks between the pre-baking and the curing steps. The conductivity was not very different, despite the one week or two week aging.

What is claimed is:

1. A composition, comprising:
at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and
wherein the metal complex has a solubility at 25° C. of at least 100 mg/ml in at least one polar protic solvent.

2. The composition of claim 1, wherein the metal complex has a solubility at 25° C. of at least 250 mg/ml in at least one polar protic solvent.

3. The composition of claim 1, wherein the metal complex has a solubility at 25° C. of at least 500 mg/ml in at least one polar protic solvent.

4. The composition of claim 1, further comprising at least one polar protic solvent.

5. The composition of claim 1, further comprising at least one polar protic solvent, and wherein the polar protic solvent is water, ethanol, amine or PEG.

6. The composition of claim 1, further comprising at least two polar protic solvents mixed together, wherein one of the polar protic solvents is PEG.

7. The composition of claim 1, wherein the metal complex comprises only one metal.

8. The composition of claim 1, wherein the metal is in an oxidation state of (I) or (II).

9. The composition of claim 1, wherein the metal is silver, gold, copper, platinum or ruthenium.

10. The composition of claim 1, wherein the metal is silver.

11. The composition of claim 1, wherein the first ligand is a monodentate ligand, a bidentate ligand, or a tridentate ligand.

12. The composition of claim 1, wherein the first ligand comprises at least two amine groups.

13. The composition of claim 1, wherein the first ligand comprises at least two unsubstituted amine groups.

14. The composition of claim 1, wherein the first ligand comprises at least two amines groups, wherein at least one amine group is substituted with a polar group or a linear alkane.

15. The composition of claim 1, wherein the first ligand is ethylenediamine.

16. The composition of claim 1, wherein the first ligand volatizes upon heating at a temperature of 200° C. or less.

17. The composition of claim 1, wherein the first ligand volatizes upon heating at a temperature of 150° C. or less.

18. The composition of claim 1, wherein the second ligand is a carboxylate.

19. The composition of claim 1, wherein the second ligand is a carboxylate comprising a linear, branched or cyclic alkyl group.

20. The composition of claim 1, wherein the second ligand is a carboxylate represented by —O—C(O)—R, wherein R is an alkyl group having 5 carbon atoms or less.

21. The composition of claim 1, wherein the second ligand is acetate or isobutyrate.

22. The composition of claim 1, wherein the second ligand volatizes upon heating at a temperature of 200° C. or less.

23. The composition of claim 1, wherein the second ligand volatizes upon heating at a temperature of 150° C. or less.

24. The composition of claim 1, wherein the metal is silver, the first ligand comprises at least two unsubstituted amine groups, and the second ligand is a carboxylate.

25. The composition of claim 1, wherein the metal complex consist essentially of the metal, the first ligand, and the second ligand.

26. The composition of claim 1, wherein the metal complex is

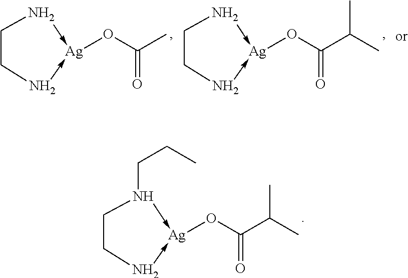

27. The composition of claim 1, wherein the composition has a sharp decomposition transition beginning at a temperature of 200° C. or less.

28. The composition of claim 1, wherein the composition has a sharp decomposition transition beginning at a temperature of 150° C. or less.

29. The composition of claim 1, wherein the composition is substantially free of nanoparticles.

30. The composition of claim 1, wherein the composition can be stored at 25° C. for at least 100 hours without substantial deposition of metal (O).

31. The composition of claim 1, wherein the composition comprises at least two metal complexes each comprising a different metal, wherein the at least two metal complexes are adapted to form a metal alloy upon heating.

32. A composition, comprising:
at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex, and wherein the metal complex is represented by formula (I): 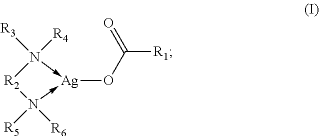
wherein:
R₁ is an optionally substituted alkyl group,
R₂ is an optionally substituted alkylene group that, together with the Ag and the two amine groups, forms a 4-member, 5-member or 6-member ring, and
R₃, R₄, R₅ and R₆ are each independently a hydrogen or a polar-terminated alkyl group.

33. The composition of claim 32, wherein R₁ is linear, branched, or cyclic alkyl group with 5 carbon atoms or less.

34. The composition of claim 32, wherein R₁ is substituted with at least one heteroatom.

35. The composition of claim 32, wherein R₂ is a linear or branched alkylene group with 5 carbon atoms or less.

36. The composition of claim 32, wherein R₂ is substituted with at least one heteroatom.

37. The composition of claim 32, wherein R₃, R₄, R₅ and R₆ are each hydrogen.

38. The composition of claim 32, wherein at least one of R₃, R₄, R₅ and R₆ is a polar-terminated alkyl group.

39. The composition of claim 32, wherein R₁ is methyl or isopropyl, R₂ is —CH₂—CH₂— or 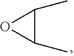
and R₃, R₄, R₅ and R₆ are each hydrogen.

40. The composition of claim 32, further comprising at least one polar protic solvent.

41. The composition of claim 32, further comprising at least one polar protic solvent, and wherein the metal complex has a solubility of at least 250 mg/ml in the polar protic solvent.

42. A method comprising: depositing an ink on a substrate, wherein the ink comprises a composition according to claims 1-41, and
reducing the composition to produce a metallic conductive film.

43. The method of claim 42, wherein the substrate is an organic substrate, and wherein the ink does not react with the organic substrate.

44. The method of claim 42, wherein the depositing step is carried out by inkjet deposition.

45. The method of claim 42, wherein the ink is substantially free of nanoparticles before deposition.

46. The method of claim 42, wherein the ink is substantially free of nanoparticles after deposition.

47. The method of claim 42, wherein the reducing step is carried out by heating.

48. The method of claim 42, wherein the reducing step is carried out by irradiating.

49. The method of claim 42, wherein the reducing step is carried out at room temperature with a reactive gas.

50. The method of claim 42, wherein the reducing step is carried out by heating at a temperature of 250° C. or less, 200° C. or less, or 150° C. or less.

51. The method of claim 42, wherein the metallic conductive film is in the form of a line, with a conductivity of at least 1,000 S/m, at least 10,000 S/m, or at least 100,000 S/m.

52. The method of claim 42, wherein the metallic conductive film is in the form of a line, and the difference between the work function of the metallic conductive film and the work function of the native metal is less than 25%, less than 10%, or less than 5%.

53. The method of claim 42, wherein the metallic conductive film is in the form of a metal grid comprising repetitively patterned structures forming a grid-like network of vertex-shared polygons and polygon-like structures with a varying number of vertices.

54. The composition of claim 1, wherein the metal complex is represented by formula (II): 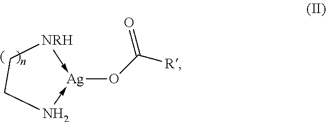
wherein n is an integer of 1 or more, R is H or linear alkane, and R′ is branched, linear or cyclic alkane; wherein the composition further comprises at least one polar protic solvent; and wherein the silver complex has a solubility of at least 250 mg/ml in said polar protic solvent at 25° C.

55. A composition, comprising:
at least one metal complex comprising at least one metal and at least one first ligand and one second ligand, wherein the first ligand is a sigma donor to the metal and volatilizes upon heating the metal complex, and wherein the first ligand is not ammonia, and wherein the second ligand is different from the first ligand and also volatilizes upon heating the metal complex; and
wherein the metal complex has a solubility at 25° C. of at least 100 mg/ml in at least one polar protic solvent.

56. A composition comprising at least one composition comprising: (i) at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; (ii) at least one solvent, wherein the solvent is a polar protic solvent.

57. The composition according to claim 56, wherein the polar protic solvent is an amine compound.

58. A method of making a composition, the composition comprising:
at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and
wherein the metal complex has a solubility at 25° C. of at least 100 mg/ml in at least one polar protic solvent, the method comprising reacting a metal complex comprising the metal and the second ligand with the first ligand.

59. A method according to claim 42, wherein the reducing step comprises at least two heating steps, including a first heating step and a second heating step, wherein the first heating step is carried out at a first temperature and the second heating step is carried out at a second temperature, and wherein the first temperature is lower than the second temperature.

60. The method of claim 59, wherein the first temperature is a fixed temperature or a range of temperature, and wherein the second temperature is a fixed temperature or a range of temperature.

61. The method of claim 59, wherein the first temperature is a fixed temperature, and wherein the second temperature is a fixed temperature.

62. The method of claim 59, wherein the method also comprises a third heating step at a third temperature.

63. The method of claim 59, wherein the method consists essentially of only the first and second heating steps.

64. The method of claim 59, wherein the first temperature is about 75° C. to about 200° C.

65. The method of claim 59, wherein the first temperature is about 100° C. to about 160° C.

66. The method of claim 59, wherein the second temperature is about 200° C. to about 400° C.

67. The method of claim 59, wherein the second temperature is about 250° C. to about 350° C.

68. The method of claim 59, wherein the first temperature is about 100° C. to about 160° C., and wherein the second temperature is about 250° C. to about 350° C.

69. The method of claim 59, wherein the first heating step is carried out with a first heating time and the second heating step is carried out with a second heating time, and wherein the first heating time is longer than the second heating time.

70. The method of claim 59, wherein the first heating step is carried out with a first heating time and the second heating step is carried out with a second heating time, and wherein the first heating time is about 3 minutes to about 20 minutes, and wherein the second heating time is about 30 seconds to about 2 minutes.

71. The method according to claim 42, wherein the reducing step comprises a first heating step in which the temperature and the time of the heating step is adapted to dry the ink but not to produce a full conversion to a final metallic conductive film.

72. A method comprising: depositing an ink on a substrate, wherein the ink comprises at least one metal complex comprising at least one metal and at least one first ligand and one second ligand, wherein the first ligand is a sigma donor to the metal and volatilizes upon heating the metal complex, wherein the second ligand is different from the first ligand and also volatilizes upon heating the metal complex; and
reducing the composition to produce a metallic conductive film, wherein the reducing step comprises at least two heating steps, including a first heating step and a second heating step, wherein the first heating step is carried out at a first temperature and the second heating step is carried out at a second temperature, and wherein the first temperature is lower than the second temperature.
